(19) United States
(12) Patent Application Publication
(10) Pub. No.: US 2014/0288467 A1
(43) Pub. Date: Sep. 25, 2014

(54) Personal Water Jet

(71) Applicant: BUBBLE LOVE, LLC, Culver City, CA (US)

(72) Inventor: David D. Heilman, Geneseo, IL (US)

(73) Assignee: BUBBLE LOVE, LLC, Culver City, CA (US)

(21) Appl. No.: 14/217,230

(22) Filed: Mar. 17, 2014

Related U.S. Application Data
(60) Provisional application No. 61/802,253, filed on Mar. 15, 2013.

(51) Int. Cl. A61H 19/00

(52) U.S. Cl. CPC A61H 19/34
USPC 601/16

(57) ABSTRACT

Method and apparatus for hydrotherapeutic stimulation using a personal water jet comprising a housing having an exterior handle portion and an interior cavity portion with a water inlet positioned in the housing for fluid communication with a water source. A power compartment is contained within the internal cavity and includes first and second chambers. A cap having a control port may form the top portion of the power compartment. A pump body positioned therein may form the bottom portion of the power compartment. A pump motor is positioned within the first chamber and a control port connects to a switch located external of the first chamber. A battery positioned within the second chamber is electrically connected to pump motor and battery. The electrically connected control circuit includes a switch, pump motor and battery for generation of a pressurized stream of water discharged through the water stream nozzle.

### CROSS REFERENCE TO RELATED APPLICATIONS

This patent application claims priority from provisional U.S. Pat. App. No. 61/789,899 filed on Mar. 15, 2013 which is incorporated by reference herein in its entirety. The present application claims priority from and is a continuation-in-part of pending non-provisional utility patent application Ser. No. 12,883,166 filed on Sep. 15, 2010 entitled “Feminine Hydro-therapeutic Massage Device”, which was a continuation of non-provisional utility patent application having Ser. No. 11,980,940 filed on Oct. 31, 2007 (U.S. Pat. No. 7,824,351), which was a continuation of non-provisional utility patent application having Ser. No. 11,016,046 filed on Dec. 18, 2004 (U.S. Pat. No. 7,335,175) which claimed priority from provisional patent application having serial number 60,551,522 filed on Mar. 5, 2004. The present application is also a continuation in part of non-provisional patent application having Ser. No. 13,412,460 which was a continuation in-part of non-provisional patent application having Ser. No. 12,017,329 entitled “Hydro-Therapeutic Massage Device” and filed on Jan. 21, 2008 (now abandoned) and non-provisional patent application having Ser. No. 12,012,598 entitled “Pressure Equalization and Vent System for Submersed Waterproof Case” filed on Feb. 4, 2008, all of which are incorporated by reference herein.

### FIELD OF THE INVENTION

The invention relates to the field of portable personal hydrotherapy stimulation devices submersible in water for massage therapy to a selected area of a user's body.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### AUTHORIZATION PURSUANT TO 37 C.F.R. §1.171 (d)(c)

A portion of the disclosure of this patent document contains material which is subject to copyright and trademark protection. The copyright owner has no objection to the facsimile reproduction by anyone of the patent document or the patent disclosure, as it appears in the Patent and Trademark Office patent file or records, but otherwise reserves all copyrights whatsoever.

### DETAILED DESCRIPTION

### BRIEF DESCRIPTION OF DRAWINGS

FIG. 1 shows a front perspective of the personal water jet with an attachment.

FIG. 2 is a side view of the personal water jet of FIG. 1 submerged in water.

FIG. 3 is a rear view of the personal water jet of FIG. 1.

FIG. 4 is a front view of the personal water jet of FIG. 1 without the attachment.

FIG. 5 illustrates the underside of the personal water jet.

FIG. 6 illustrates a cross-sectional side view of the personal water jet housing and the interior portion.

FIG. 7 illustrates a detailed cross-sectional side view of one embodiment of the personal water jet and its internal components.

FIG. 8 illustrates a detailed cross-sectional rear view of the internal components of one embodiment of the personal water jet.

FIG. 8A illustrates the bottom view of power compartment formed as the pump body.

FIG. 9 illustrates a detailed cross-sectional perspective view of the internal components of one embodiment of the personal water jet.

FIG. 9A illustrates a detailed view of the top portion of the power compartment

FIG. 9B illustrates a detailed view of the underside of the power compartment top cap underside.

FIG. 9C illustrates a detailed top view of the assembled pump of one embodiment of the personal water jet.

FIG. 10 is a graphical representation of one embodiment of the personal water jet product in use by a female user for personal stimulation.

FIG. 11 illustrates a cross-sectional side view of the personal water jet housing and the interior portion.

FIG. 12 illustrates a detailed cross-sectional side view of one embodiment of the personal water jet and its internal components.

FIG. 13 illustrates a detailed cross-sectional rear view of one embodiment of the internal components of the personal water jet.

FIG. 14 illustrates a detailed cross-sectional side view of one embodiment of the personal water jet and its internal components.

DETAILED DESCRIPTION - LISTING OF ELEMENTS

| ELEMENT DESCRIPTION | ELEMENT # |
|---|---|
| Housing | 1 |
| Handle | 2 |
| Body | 3 |
| Interior cavity | 4 |
| Water Inlet | 5 |
| Water Line Inlet | 5a |
| Water Inlet Apertures | 5b |
| Air inlet (Personal Water Jet) | 6 |
| Air inlet control valve | 7 |
| Airline (exterior) | 8 |
| Bobber | 9 |
| Personal water jet | 10 |
| Airline (interior) | 11 |
| Air-water stream generator | 12 |
| Air-water stream nozzle | 13 |
| Socket | 14 |
| Attachment | 15 |
| Power compartment | 16 |
| First chamber | 17 |
| Suction Cup | 18 |
| Annular cooling channel | 19 |
| Second Chamber | 20 |
| Cap | 21 |
| Pump body | 22 |
| Pump motor | 23 |
| Control Port | 24 |
| Cooling Port | 25 |
| Equalization chamber | 26 |
| Concentric Walls | 27 a, b, c |
| Vent | 28 |
| Membrane vent | 29 |
| Pump | 30 |
| Suction inlet | 31 |
| Discharge outlet | 32 |
| Impeller | 33 |
| Equalization Chamber Lower | 34 |
| Opening | |
| Shaft | 35 |
| Gate | 36 |
| Sonic energy fusers | 37a, b, c |
| Switch | 38 |
| Wire/Conductor | 39 |
| Control circuit (not shown) | 40 |
| Power circuit (not shown) | 41 |
| Battery | 42 |
| Switch Cover | 43 |
| Bobber Air Inlet | 44 |
| Stream (discharged) | 45 |
| Air Flow Path | 46 |
| Suction Cup Receiver | 47 |
| User | 48 |
| Water Flow Path | 49 |
| Water Proof Boot | 50 |
| Ball | 51 |
| Magnet | 52 |
| Reed Switch | 53 |
| | 54 |

### DETAILED DESCRIPTION

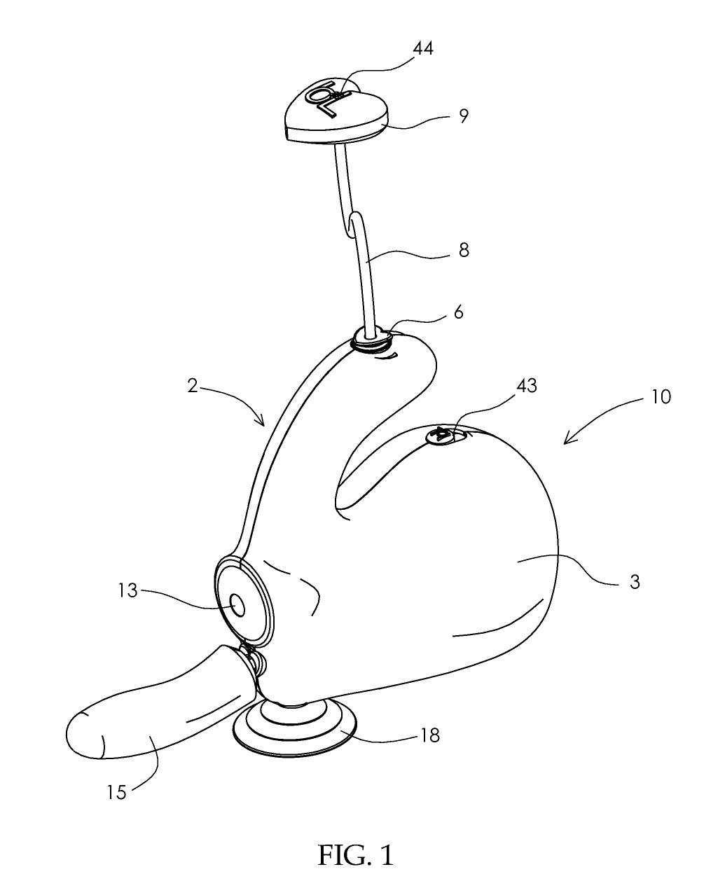

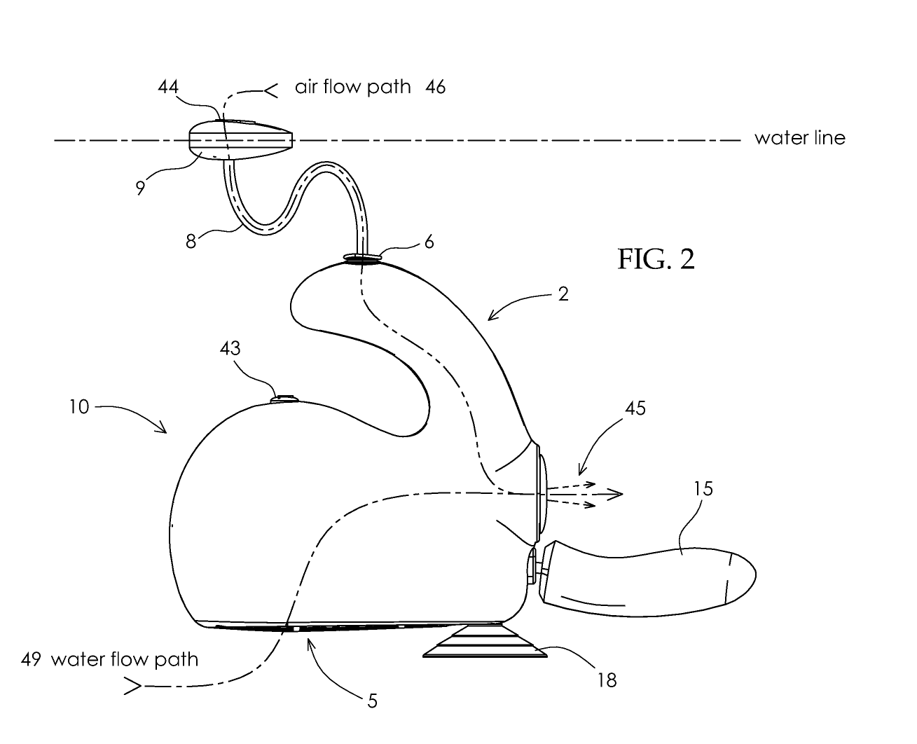

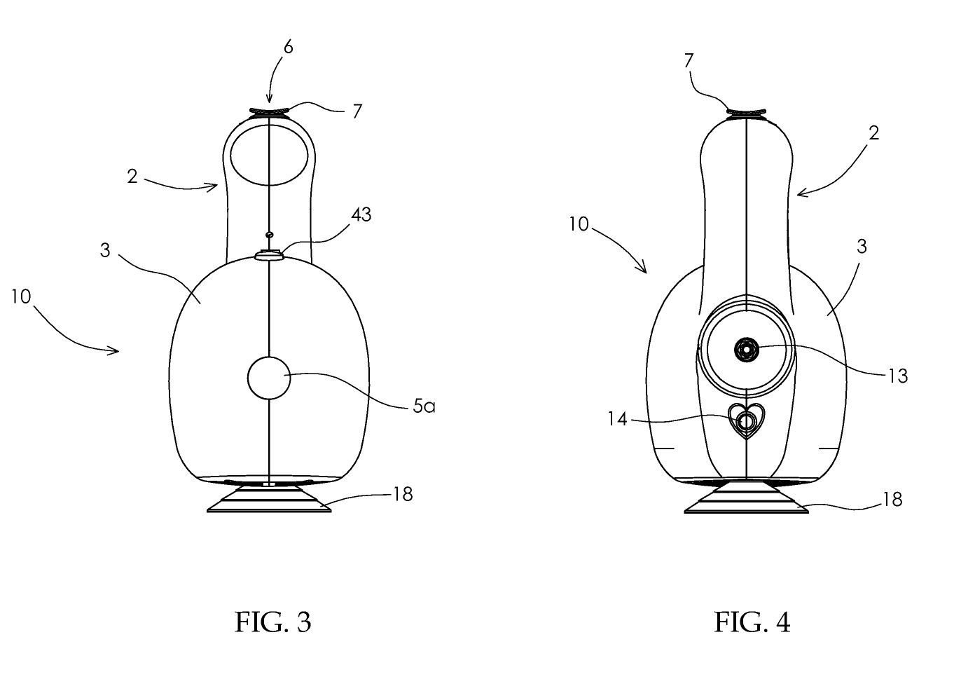

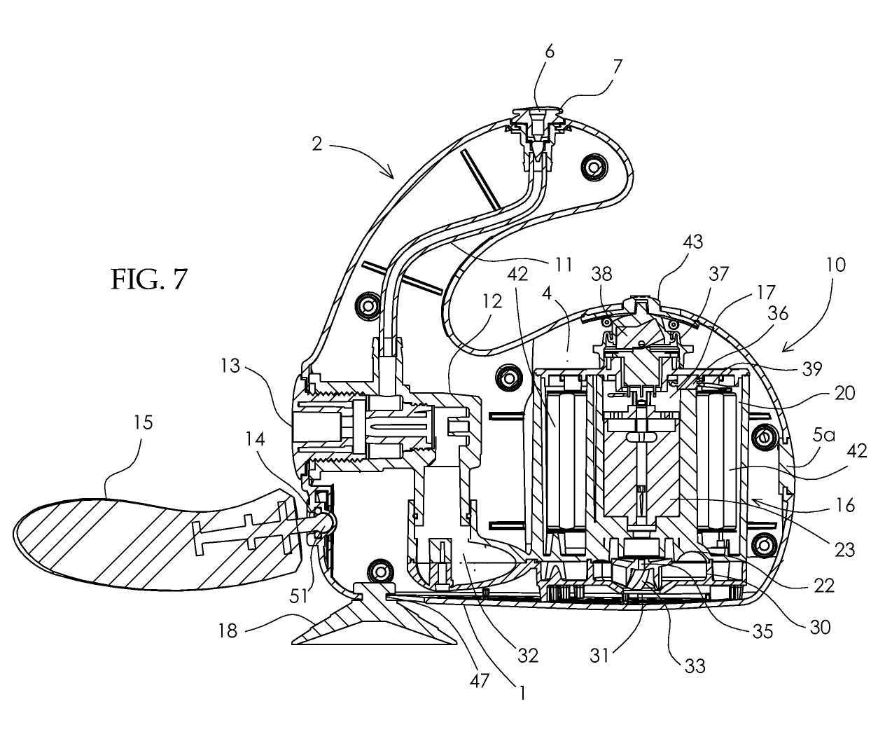

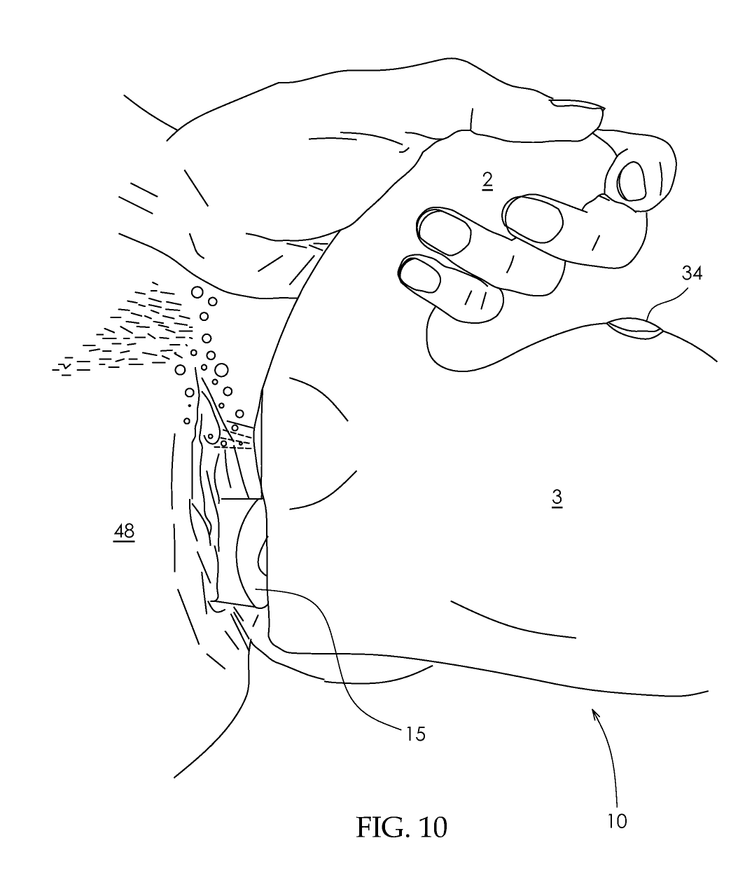

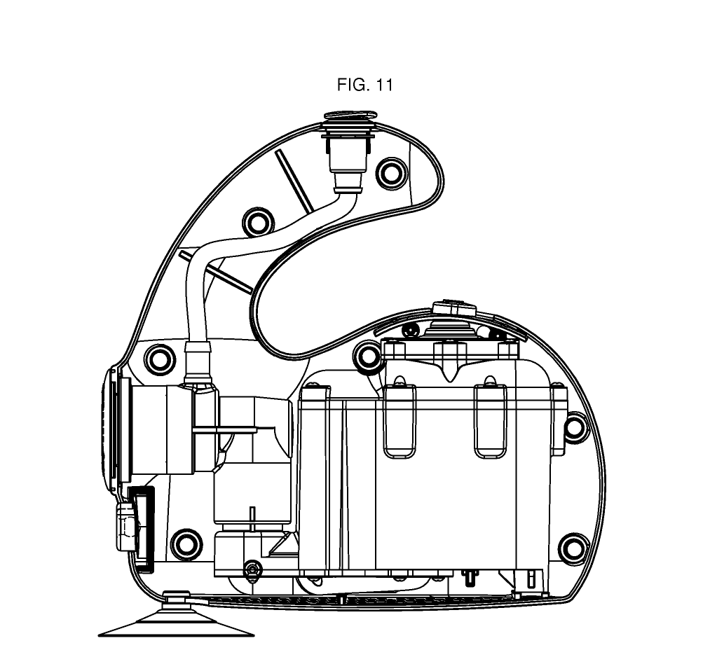

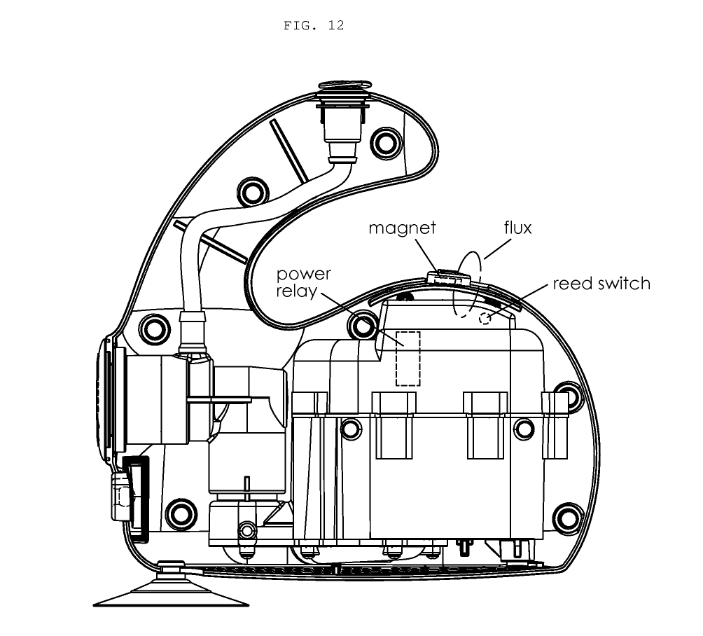

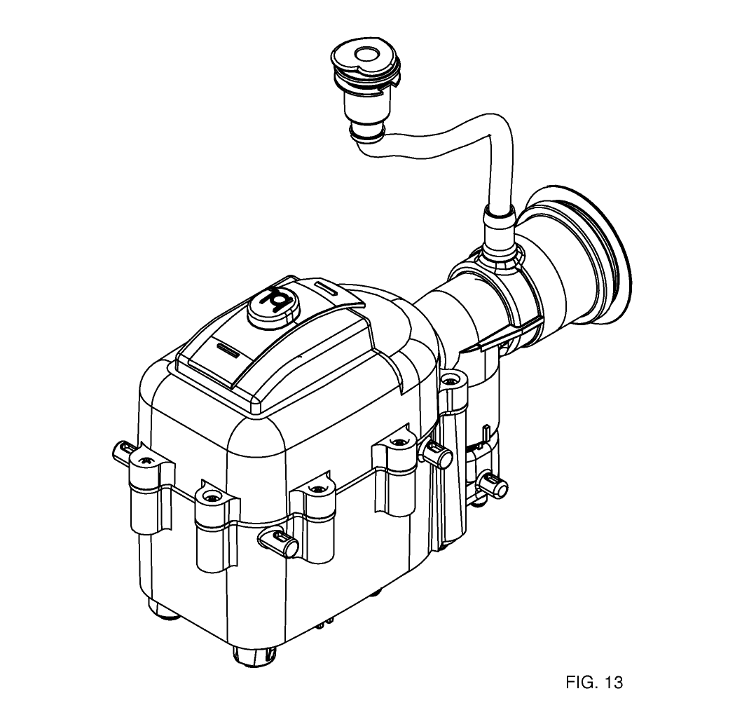

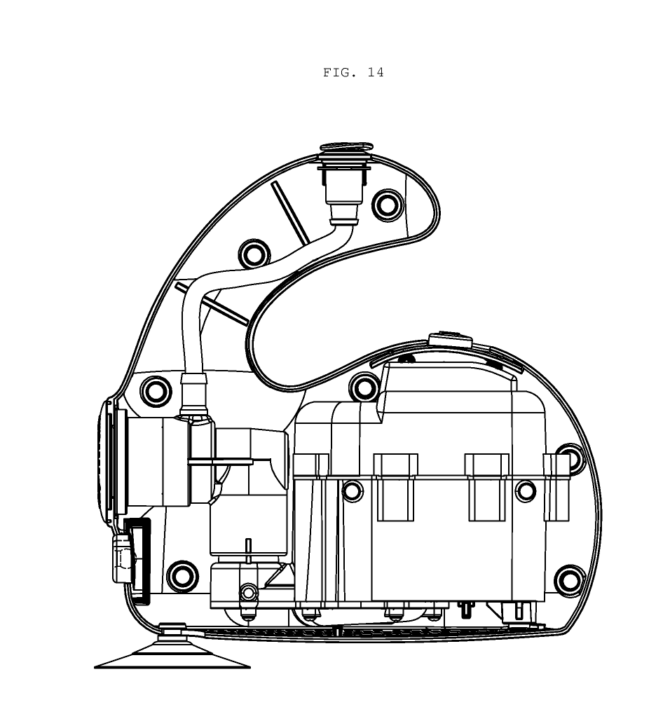

FIGS. 1-10 illustrate a personal water jet 10 useful for massage and stimulation. Referring to FIG. 1, the personal water jet 10 is functional when submerged in a contained body of water, such as found in a bathtub or whirlpool. In another embodiment, a hose or external water line (not shown) may be connected to the housing 1 to provide a continuous source of water. FIG. 3 illustrates an optional water line inlet 5a, for a hose. The housing has a body 3 and an exterior handle portion 2 and an interior cavity portion 4. A water inlet 5 is a single connection point (5a) or a plurality of apertures 5b or penetrations of the housing 1 to allow water to enter the internal cavity 4. In the embodiment shown in FIGS. 1-10, water enters through water inlet 5b, as apertures, positioned along the bottom portion of the housing 1. An air inlet 6 is positioned in the handle portion 2. The air inlet 6 is typically positioned in the upper exterior portion of the handle 2. The air inlet 6 may be used in conjunction with an air inlet control valve 7 (sometimes referred to as a throttle value) to moderate the flow of air. For submerged operation an exterior airline 8 and bobber 9 having air inlet 44 may be attached to the air inlet 6 of the air inlet control valve 7. (See FIG. 2) The air inlet 6 connected to the air-water stream generator 12, positioned in the interior cavity portion of the housing 1, allows for the induction of air into the water sucked into the personal water jet 10 for discharge through the air-water stream nozzle 13 which is positioned in the housing 1. As illustrated in FIGS. 1-10, the housing 1 of the personal water jet 10 may have at least one socket 14 allowing connection to an externally positioned attachment 15 having a ball 50 projecting therein. As one of ordinary skill will appreciate, other methods of affixing an attachment to the housing may also be used. Examples of useful attachments include vibrators, bumpers, dildos, suction cups and hooks. A suction cup 18, via suction cup receiver 47 as shown in FIG. 7, positioned in the housing 1, may be used to attach the personal water jet 10 to the wall of the water containment device (not shown), i.e. the bottom of the bathtub.

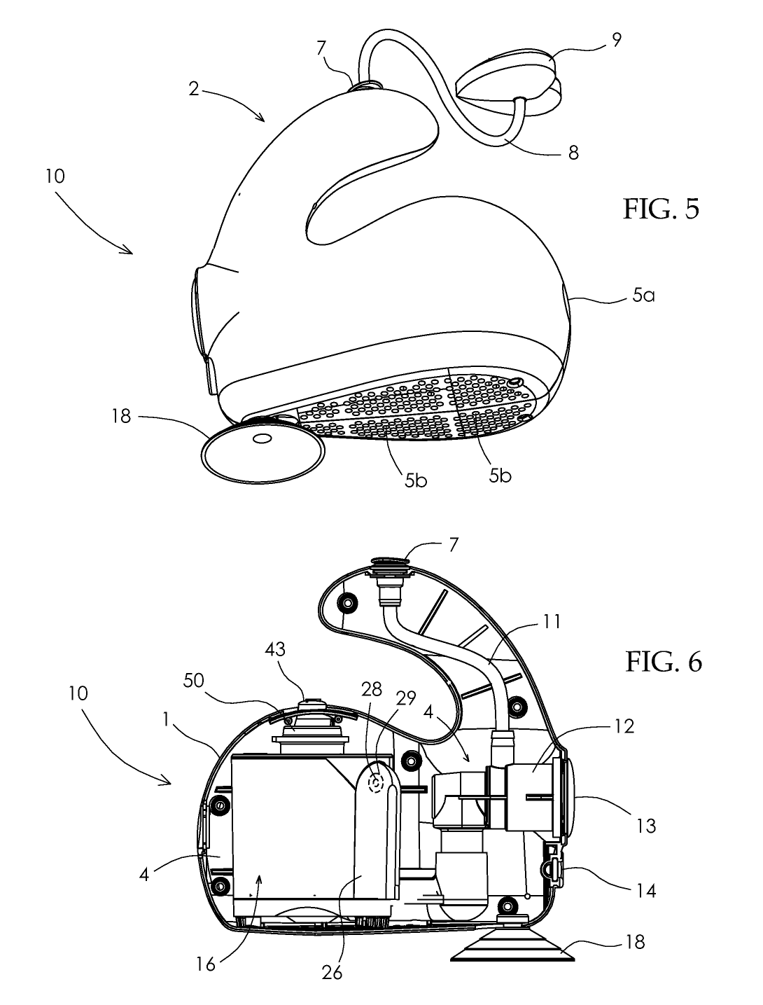

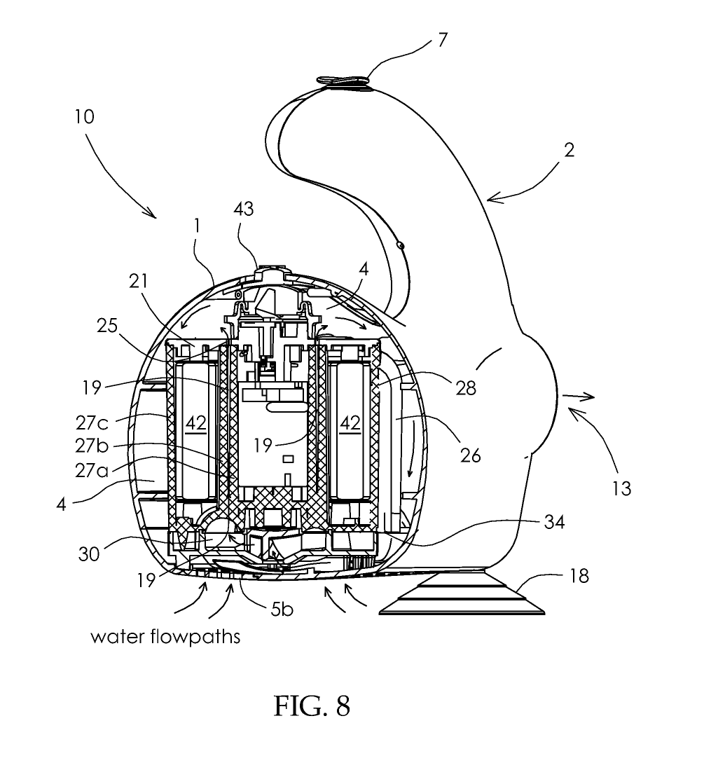

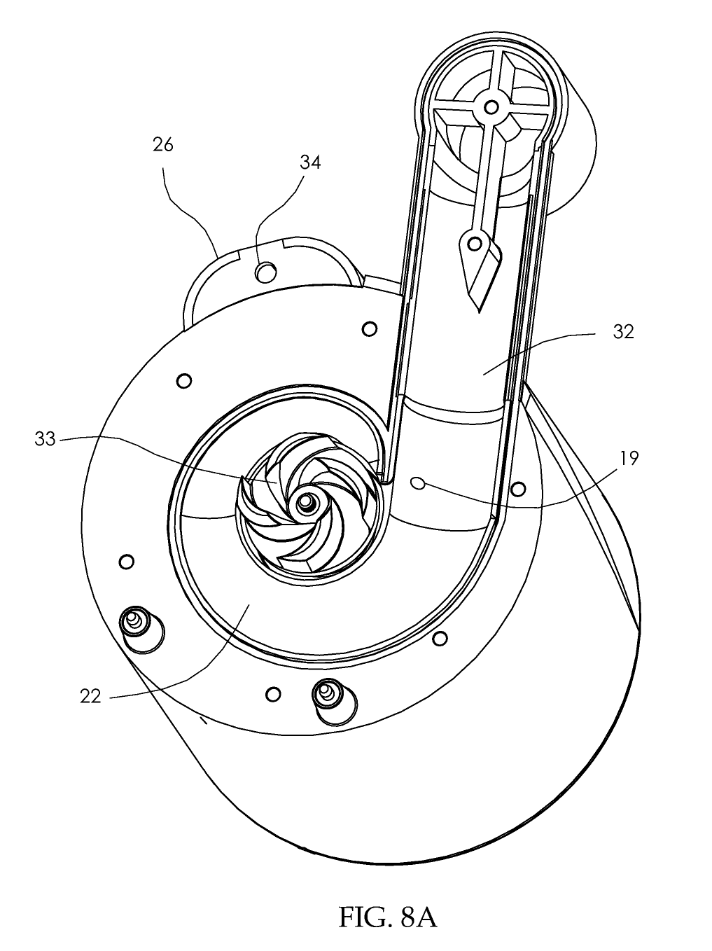

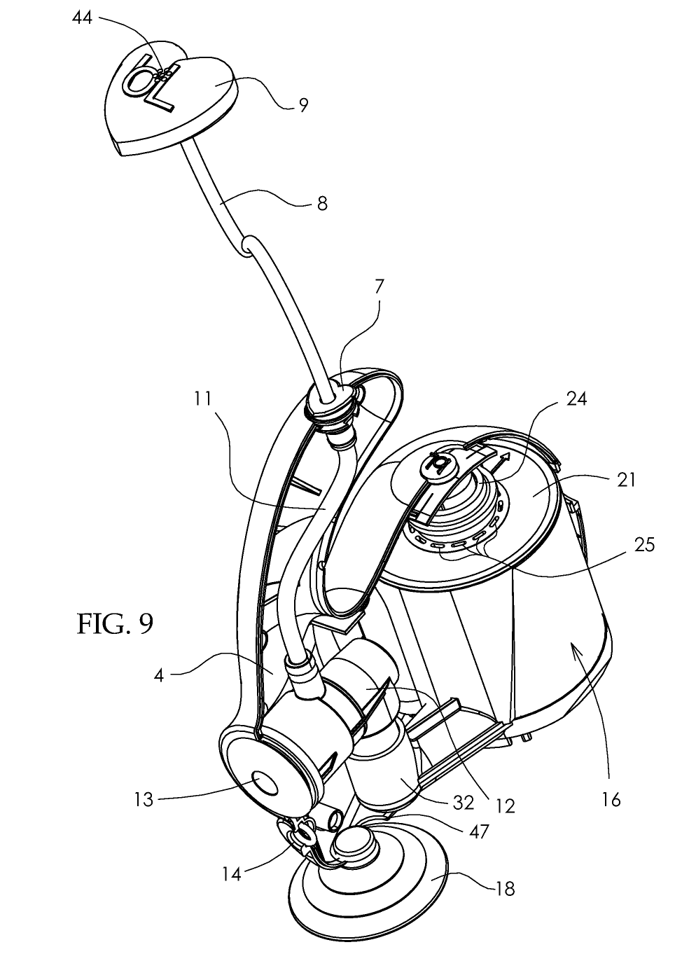

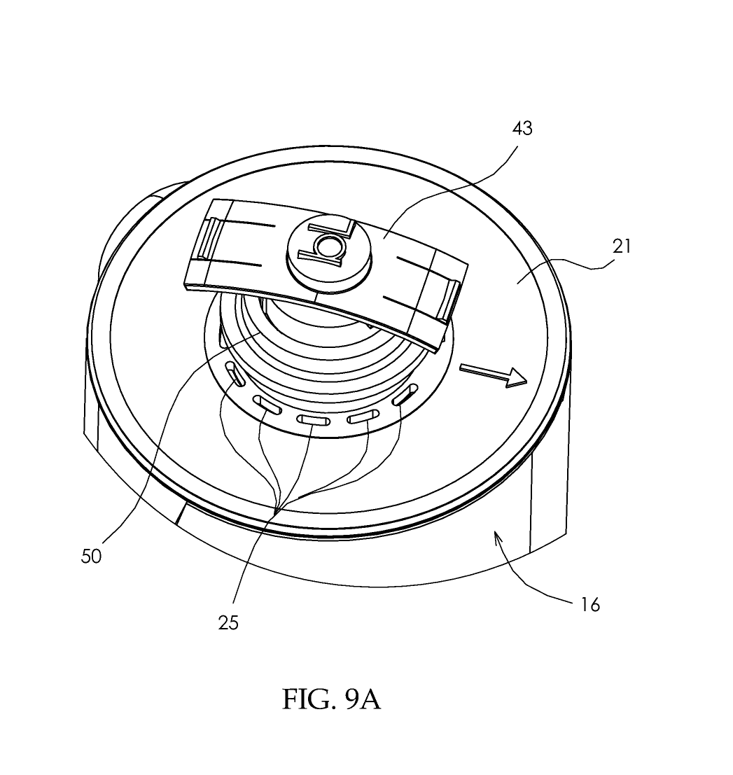

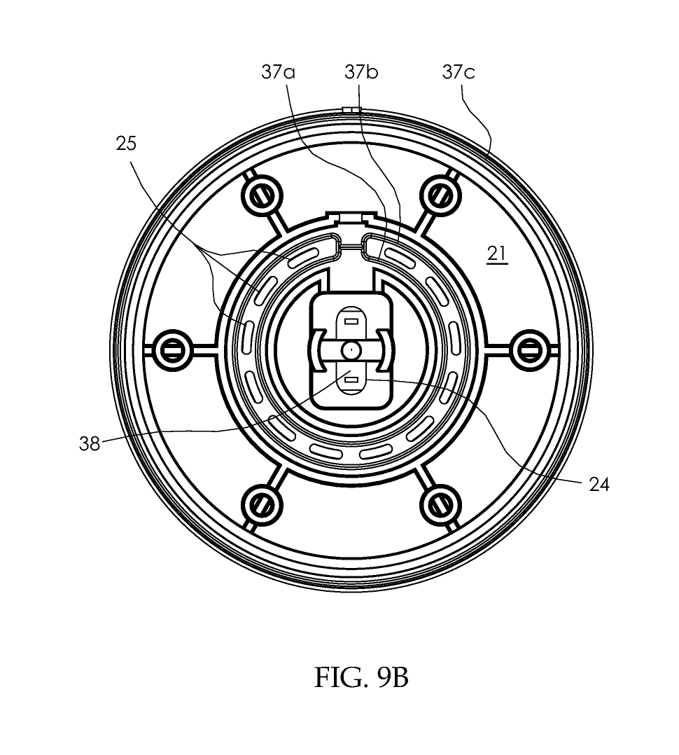

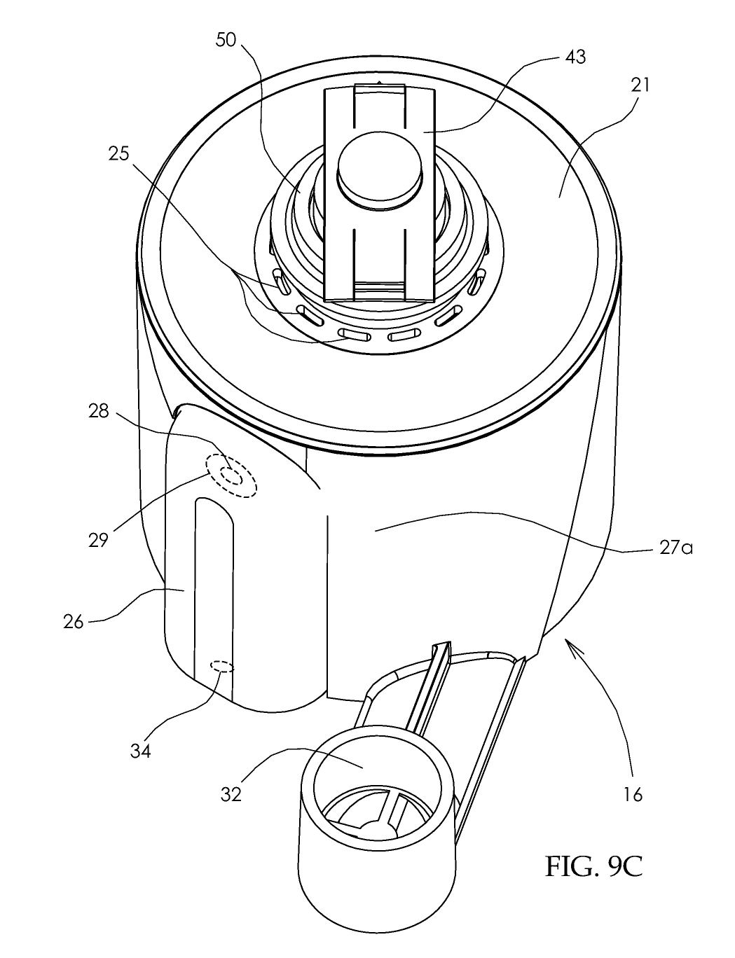

FIGS. 5-10 provide useful illustrations of the internals of the powered version of the personal water jet having. A self-contained power compartment 16 is contained within internal cavity 4. The self-contained power compartment 16 uses three (3) concentric walls to produce isolation of electrical components within the self-contained power compartment 16 while allowing the use of circulating water during operation and submersion. The concentric design also allows the pump 30, pump motor 23 and batteries 42 to be positioned closely together in a self-contained unit having a compact size, reducing the overall size of the personal water jet 10. The self-contained power compartment 16 is comprised of a first chamber 17 created by a first wall interior concentric wall 27a. The first chamber is positioned within the second chamber 20. The second chamber 20 is positioned to encompass the first chamber 17, and is created by wall 27c. Concentric walls 27a and 27b may be constructed to form an annular cooling channel 19 which is positioned between the first chamber 17 and the second chamber 20. For improved cooling, water or fluid may be pumped through the annular cooling channel 19 to assist with cooling of the batteries 42, during usage of the personal water jet 10. Although not shown, the power compartment 16 may also be constructed without annular cooling channel 19 without limitation. It should be noted that the configuration of the annular cooling channel 19 does not expose the batteries directly to water, but water passes over wall 27b adjacent the batteries 42 positioned and isolated in the second chamber 20. The concentric walls (27a, b, c) may be sealed to the cap 21 at the top above the second chamber 20 through any number of construction methods including casting, a snap or interference fit or through glue and adhesives which are well known in the art. Welding processes, such as sonic welding, well known to those of ordinary skill in the art, may also be used. To ensure a water tight fit, the underside of the cap 21 is formed to mate with concentric walls 27 with sonic energy fusers 37a, 37b, 37c, and prevent water intrusion into the first and second chambers (17, 20). See FIG. 9A illustrating the concentric nature of the walls 27, FIG. 9B illustrating the matching concentric nature of the underside of the cap 21, positioned at the top of the combined chambers and FIG. 9C illustrating the design of the pump body 22, positioned at the lower end of the chambers and forming the bottom of the chamber, which isolates the first and second chambers, (17, 20 respectively) from water intrusion. The cap 21 is configured for a control port 24, serving as bridge to a switch 38 and outer switch cover 43, and at least one cooling port 25. The cooling port(s) 25 in fluid communication with the annular cooling channel 19, penetrate cap 21 which forms the top portion of the power compartment 16. In the embodiment illustrated having annular cooling channels 25, a portion of the water pumped from the pump discharge outlet 32 is directed to and through the annular cooling channel 19, which then exits the power compartment at cooling port(s) 25 and mixes back in with water in the internal cavity 4 for eventual intake and recirculation through the pump 30 to either outlet nozzle 13 or the cooling ports 25. As one of ordinary skill will appreciate, no water from pump discharge 32 is pumped back through the power compartment 16 if additional cooling is not needed. The pump 30 is located within the power compartment 16 and has a suction inlet 31, a discharge outlet 32, an impeller 33 and a body 22 wherein the pump body 22 forms the bottom portion of the power compartment chambers. The top side of the pump body fits up to and forms either an interlocking fit or an integral fit, depending on the construction method chosen, to form the floor or bottom of the power compartment 16. The lower side of the pump 30 is formed into and integral with the pump volute to encompass the impeller 33. The suction inlet 31 is fluidly connected to the water inlet 5 and the discharge outlet 32 is fluidly connected to the air-water stream generator 12 and the annular cooling channel 19. The pump impeller 33 is positioned within the pump body 22 and pump volute between the suction inlet 31 and discharge outlet 32. As illustrated, the water stream pumped from the pump discharge outlet 32 into the annular cooling channel 19 circulates adjacent the wall which is adjacent batteries 42 and flows out through the cooling port(s) 25 positioned in cap 21 for recirculation and mixing in the internal cavity 4 of housing 1 with water pulled in through water inlet 5. See FIGS. 8 and 9 illustrating the cooling water circulation patterns.

Positioned within the first chamber 17 is the pump motor 34 having a shaft 35 and an impeller 36 affixed to the shaft 35. A control port 24, as shown, is positioned above and adjacent the power compartment 16 for connection to the switch 38 located exterior of the first chamber 17 which may be manipulated from the exterior of the housing 1. At least one battery 42 is positioned within the third chamber 20. Due to the configuration of the power compartment 16, the second chamber 20 is substantially isolated from water and is able to withstand the pressure of submersion beneath up to 1 meter of water. As will be clear to one of ordinary skill in the art, there is a power circuit 41 which is electrically connected between the pump motor 23 and the battery 42 by wire or other electrical conductor, which should be waterproof for use in the present configuration. (Power circuit 41 is not shown as it involves methods of implementation and construction well known to those of ordinary skill in the art) Additionally, there is a control circuit 40 which is electrically connected between the switch 38, the pump motor and the battery 42 by wire or other electrical conductor 39. (Control circuit 40 is not shown as it involves methods of implementation and construction well known to those of ordinary skill in the art)

To allow wires/conductors 39 to be used for a submersible device, one of ordinary skill will appreciate that gates 36 or access points are positioned in the walls 27 to allow the wire/conductors to run through or between chambers, but that such gates 36 are sealed to be waterproof with silicone or other sealant. See FIG. 9A by way of illustration.

To handle pressure build-up during use of the pump, as related to heat produced by the rechargeable batteries placed in chamber 20, an aperture or vent 28 is positioned at the upper portion of power compartment with a membrane vent 29 positioned therein. A vertically orientated equalization chamber 26 having an enclosed upper portion positioned proximate said cap 21 and an open lower portion positioned proximate said pump body. The equalization chamber 26 is positioned exteriorly adjacent the second chamber 20 and the upper portion of the equalization chamber is in fluid communication with the second chamber 20 via the vent 28 and the equalization chamber lower opening 34 is in fluid communication with the internal cavity 4 at the open lower portion.

It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

1. A personal water jet comprising:
a. A housing, said housing having an exterior handle portion and an interior cavity portion;
b. A water inlet, said water inlet positioned in said housing;
c. A water source exterior of said housing, said water source in fluid communication with said water inlet;
d. A water stream nozzle, said water stream nozzle positioned in said housing; and,
e. A power compartment contained within said internal cavity comprising:
i. A first chamber;
ii. A second chamber, said first chamber positioned therein;
iii. A cap having a control port and wherein said cap forms the top portion of said power compartment;
iv. A pump having an suction inlet, a discharge outlet, an impeller and a body wherein said upper portion of said body forms the bottom portion of said power compartment, and said pump body contains said suction inlet which is in fluid communication with said water inlet and wherein said impeller is positioned within said body and between said suction inlet and discharge outlet;
v. A pump motor having a shaft and an impeller affixed to said shaft and wherein said pump motor is positioned within said first chamber and said control port connects to a switch located external of said first chamber;
vi. At least one battery positioned within said second chamber;
vii. At least one power circuit, wherein said power circuit is electrically connected between said pump motor and said at least one battery; and,
viii. At least one control circuit, wherein said control circuit is electrically connected between said switch, said pump motor, said at least one battery;
f. wherein a pressurized stream of water is discharged from said water stream nozzle during operation.

2. The personal water jet according to claim 1 wherein at least one annular cooling channel is positioned between said first chamber and said second chamber and said pump discharge outlet is also in fluid communication with said at least one annular cooling channel.

3. The personal water jet according to claim 1 wherein at least one battery is rechargeable and wherein at least one recharging circuit cooperates with a charger positioned exterior of said housing via at least one exterior positioned charge port electrically connected between said at least one battery and said recharging circuit.

4. The personal water jet according to claim 3 wherein said at least one charge port is aligned with said second chamber.

5. The personal water jet according to claim 1 wherein said housing has as at least one socket allowing connection to an externally positioned attachment.

6. The personal water jet according to claim 1 wherein said external water source is via a hose coupled to a water source including a shower, a bath tub spigot or a water faucet.

7. The personal water jet according to claim 1 wherein said external water source is via a contained water source and water enters said internal compartment through at least one orifice in said housing.

8. The personal water jet according to claim 5 wherein said externally positioned attachment is selected from the consisting group of an artificial phallus, a dildo, a vibratory device, a vibrator, a suction cup, a bumper or a hook and or a combination thereof.

9. The personal water jet according to claim 1 further comprising:
a. A vent positioned at the upper portion of said power compartment;
b. A vertically orientated equalization chamber having an enclosed upper portion positioned proximate said cap and an open lower portion positioned proximate said pump body; and,
c. wherein said equalization chamber is positioned exteriorly adjacent said second compartment and wherein said upper portion of said equalization chamber is in fluid communication with said second chamber via said vent and said lower portion of said equalization chamber is in fluid communication with said internal cavity at said open lower portion.

10. The personal water jet according to claim 9 wherein said personal water jet is submersible in water.

11. A personal water jet comprising:
a. A housing, said housing having an exterior handle portion and an interior cavity portion;
b. A water inlet, said water inlet positioned in said housing;
c. A water source exterior of said housing, said water source in fluid communication with said water inlet;
d. An air inlet, said air inlet positioned in said housing;
e. An air source exterior of said housing, said air source in fluid communication with said air inlet;
f. An air-water stream generator positioned in said interior cavity portion and in fluid communication with said water inlet and said air inlet;
g. An air-water stream nozzle, said air-water stream nozzle positioned in said housing; and,
h. A power compartment contained within said internal cavity comprising:
i. A first chamber;
ii. A second chamber, said first chamber positioned therein;
iii. An annular cooling channel positioned between said first chamber and said second chamber;
iv. A cap having a control port and at least one cooling port, said at least one cooling port connected to said annular cooling channel and wherein said cap forms the top portion of said power compartment;
v. A pump having an suction inlet, a discharge outlet, an impeller and a body wherein said upper portion of said body forms the bottom portion of said power compartment, and said pump body contains said suction inlet which is fluidly connected to said water inlet, said discharge outlet is fluidly connected to said air-water stream generator and said annular cooling channel and wherein said impeller is positioned within said body and between said suction inlet and discharge outlet;
vi. A pump motor having a shaft and an impeller affixed to said shaft and wherein said pump motor is positioned within said first chamber and said control port connects to a switch located external of said first chamber;
vii. At least one battery positioned within said second chamber;
viii. At least one power circuit, wherein said power circuit is electrically connected between said pump motor and said at least one battery;
ix. At least one control circuit, wherein said control circuit is electrically connected between said switch, said pump motor, said at least one battery;
x. A vent positioned at the upper portion of said power compartment;
xi. A vertically orientated equalization chamber having an enclosed upper portion positioned proximate said cap and an open lower portion positioned proximate said pump body and wherein said equalization chamber is positioned exteriorly adjacent said second compartment and wherein said upper portion of said equalization chamber is in fluid communication with said second chamber via said vent and said lower portion of said equalization chamber is in fluid communication with said internal cavity at said open lower portion.

12. The personal water jet according to claim 11 wherein a switch cover is in communication with said switch and said switch cover is positioned in said housing for external manipulation.

13. The personal water jet according to claim 11 wherein an air control is positioned at the air inlet to vary the amount of air induced by the air-water stream generator into said air-water discharged.

14. The personal water jet according to claim 11 wherein at least one battery is rechargeable and wherein at least one recharging circuit cooperates with a charger positioned exterior of said housing via at least one exterior positioned charge port electrically connected between said at least one battery and said recharging circuit.

15. The personal water jet according to claim 14 wherein said at least one charge port is aligned with said second chamber.

16. The personal water jet according to claim 11 wherein said personal water jet is submersible in water.

17. A personal water jet comprising:
a. A housing further comprising:
i. A rigid outer shell having both a body portion and a handle portion;
ii. An internal cavity positioned within said rigid outer shell;
iii. A water inlet located in the body portion of said rigid outer structure;
iv. An air inlet located in the handle portion of said rigid outer structure;
v. At least one outlet orifice positioned in said rigid outer shell;
b. An air-water stream generator coupled to a water inlet orifice and an air inlet orifice, said air-water stream generator encompassed by said housing, wherein said water inlet orifice is in fluid communication with a water stream source and wherein said air inlet orifice is in fluid communication with an air source through an external air intake port connected to an air suction conduit;
c. A low-voltage direct current pump means imparting an increase in pressure and flow of water within said housing to said outlet nozzle;
d. An electrical source electrically connected to said pump means;
e. A handle, wherein said handle is attached to said housing;
f. An air-water stream outlet nozzle located within said fore portion of said housing and connected to said air-water stream generator for transmission of said air-water stream onto said human user's body positioned fore of said air-water stream outlet nozzle; and,
g. Wherein said handle allows the human user to control said air-water stream outlet nozzle and stimulation upon said human user's body by said air-water stream.

18. The personal water jet according to claim 17 and further wherein said housing has at least one socket formed therein for cooperative engagement with an attachment.

19. The personal water jet according to claim 17 wherein said personal water jet is submersible in a water source and further wherein a bobber is fluidly attached to said external air intake port to maintain communication with said air source during submerged operation of said personal water jet.

20. The personal water jet according to claim 17 and further wherein said air-water stream outlet nozzle is an oscillating nozzle to produce an air-water stream having oscillating properties for transmission onto said human user's lower body for increased stimulation.

21. A personal water jet comprising:
a. A housing, said housing having an exterior handle portion and an interior cavity portion;
b. A water inlet, said water inlet positioned in said housing;
c. A water source exterior of said housing, said water source in fluid communication with said water inlet;
d. A water stream nozzle, said water stream nozzle positioned in said housing; and,
e. A power compartment contained within said internal cavity comprising:
i. A first chamber;
ii. A second chamber, said first chamber positioned therein;
iii. A cap having a control port and wherein said cap forms the top portion of said power compartment;
iv. A pump having an suction inlet, a discharge outlet, an impeller and a body wherein said upper portion of said body forms the bottom portion of said power compartment, and said pump body contains said suction inlet which is in fluid communication with said water inlet and wherein said impeller is positioned within said body and between said suction inlet and discharge outlet;
v. A pump motor having a shaft and an impeller affixed to said shaft and wherein said pump motor is positioned within said first chamber and said control port connects to a switch located external of said first chamber;
vi. At least one battery positioned within said second chamber;
vii. At least one power circuit, wherein said power circuit is electrically connected between said pump motor and said at least one battery; and,
viii. At least one control circuit, wherein said control circuit is electrically connected between said switch, said pump motor, said at least one battery;
ix. Wherein the said least one power circuit is controlled by a magnetic switch assembly employing a reed switch;
f. wherein a pressurized stream of water is discharged from said water stream nozzle during operation.
